(19) United States
(12) Patent Application Publication
(10) Pub. No.: US 2012/0026101 A1
(43) Pub. Date: Feb. 2, 2012

(54) ELECTRIC PAPER ASSOCIATED WITH TOUCH PANEL

(75) Inventors: Hee Bum Lee, Gyunggi-do (KR); Sang Jin Kim, Gyunggi-do (KR); Kyoung Soo Chae, Gyunggi-do (KR); Yong Soo Oh, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/913,680

(22) Filed: Oct. 27, 2010

(30) Foreign Application Priority Data
Jul. 27, 2010 (KR) 1020100072366

(51) Int. Cl. G06F 3/041

(52) U.S. Cl. 345/173

(57) ABSTRACT

Disclosed herein is an electronic paper associated with a touch panel. The electronic paper 100 associated with a touch panel according to the present embodiment includes an electronic ink 110 provided between an upper substrate 128 and a lower substrate 135, an upper electrode 120 provided on a bottom surface of the upper substrate 128 to drive the electronic ink 110 and to generate a signal, an lower electrode 130 provided on a top surface of the lower substrate 135 to drive the electronic ink 110, and a sensing electrode 140 formed on a transparent substrate 145 provided on a top side of the upper substrate 128 to form capacitance with the upper electrode 120 due to the signal of the upper electrode 120 and sensing change in the capacitance when the transparent substrate 145 is touched by an input unit 150.

### CROSS REFERENCE TO RELATED APPLICATION

This application claims the benefit of Korean Patent Application No. 10-2010-0072366, filed on Jul. 27, 2010, entitled “Electronic Paper Associated With Touch Panel”, which is hereby incorporated by reference in its entirety into this application.

### BACKGROUND OF THE INVENTION

1. Technical Field

The present invention relates to an electronic paper associated with a touch panel.

2. Description of the Related Art

An electronic paper is a kind of reflective display. The electronic paper has high resolution, wide viewing angle, and excellent readability due to high contrast ratio between bright white background and black particles, and also has bistability that can maintain an image even after the supply of power is interrupted, thereby making it possible to minimize power loss. Therefore, the electronic paper has a long life span of a battery, thereby making it possible to readily reduce costs and reduce weight. In addition, similar to existing paper, the electronic paper can be most easily manufactured to have a large area as compared to any other displays. The electronic paper does not use a glass substrate, a backlight, and a polarizing plate, such that it can be manufactured having a thickness and a weight similar to those of paper.

Despite the advantages of the electronic paper as described above, the electronic paper according to the prior art should be operated using a separate key pad, or the like, such that it is difficult to intuitively input information. A touch panel has been in the limelight as the most effective unit for intuitively inputting information. The touch panel is mounted on the display surface of an image display device such as an electronic organizer, a flat panel display including a liquid crystal display (LCD), a plasma display panel (PDP), an electroluminescence (El) element or the like, or a cathode ray tube (CRT) and is used for a user to select the information desired while viewing the image display device. In addition, the touch panel is classified into a resistive type, a capacitive type, an electro-magnetic type, a surface acoustic wave (SAW) type, and an infrared type. Among others, the capacitive type is capable of implementing high transmittance, excellent durability, and a multi-touch, thereby being used in various fields. However, in the prior art, there is no technology capable of integrally combining an electronic paper with a capacitive touch panel, while maintaining a thin thickness, which is the advantage of the electronic paper.

### SUMMARY OF THE INVENTION

The present invention has been in made an effort to provide an electronic paper associated with a touch panel capable of intuitively inputting information by combining an electronic paper with a touch panel in a mutual capacitive scheme.

An electronic paper associated with a touch panel according to a preferred embodiment of the present invention includes: an electronic ink provided between an upper substrate and a lower substrate; an upper electrode provided on a bottom surface of the upper substrate to drive the electronic ink and generate a signal; a lower electrode provided on a top surface of the lower substrate to drive the electronic ink; and a sensing electrode formed on a transparent substrate provided on a top side of the upper substrate to form capacitance with the upper electrode due to the signal and senses the change in the capacitance when the transparent substrate is touched by an input unit.

Herein, the sensing electrode is formed on the transparent substrate and is then attached to the upper substrate using an adhesive layer.

Further, the adhesive layer is an optical clear adhesive (OCA).

Further, when the transparent substrate is touched by the input unit, the lower electrode has high-impedance.

Further, the electronic ink is a twist ball type or an electrophoresis type.

Further, the upper electrode is a thin film transistor (TFT) electrode.

Further, the lower electrode is a common electrode.

Further, the sensing electrode is made of a conductive polymer.

Further, the conductive polymer includes poly-3, 4-ethylenedioxythiophene/polystyrenesulfonate (PEDOT/PSS), polyaniline, polyacetylene, or polyphenylenevinylene.

### BRIEF DESCRIPTION OF THE DRAWINGS

FIGS. 1 and 2 are cross-sectional views of an electronic paper associated with a touch panel according to a preferred embodiment of the present invention;

FIG. 3 is a plan view of the upper electrode and the sensing electrode of FIG. 1;

FIGS. 4 and 5 are partially enlarged views enlarging portion “A” of the electronic paper associated with a touch panel of FIG. 1; and

FIGS. 6 to 8 are cross-sectional views showing an operation process of the electronic paper associated with a touch panel of FIG. 1.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “upper portion”, “lower portion”, “top surface”, “bottom other surface” and so on are used to distinguish one element from another element, and the elements are not defined by the above terms. Further, in describing the present invention, a detailed description of related known functions or configurations will be omitted so as not to obscure the subject of the present invention.

For your reference, the term ‘touch’ used throughout the specification is widely interpreted as being in proximity by a considerable distance as well as being in direct contact. In other words, an electronic paper associated with a touch panel according to the present invention should be interpreted as sensing while being in proximity of an input unit by a considerable distance as well as being in direct contact therewith.

Hereinafter, preferred embodiments of the present invention will be described in detail with reference to the accompanying drawings.

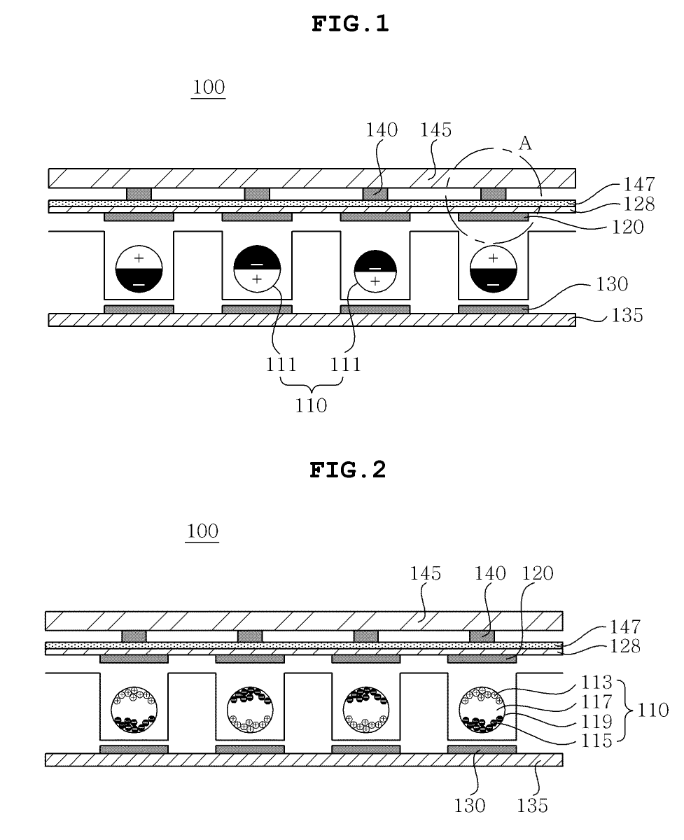

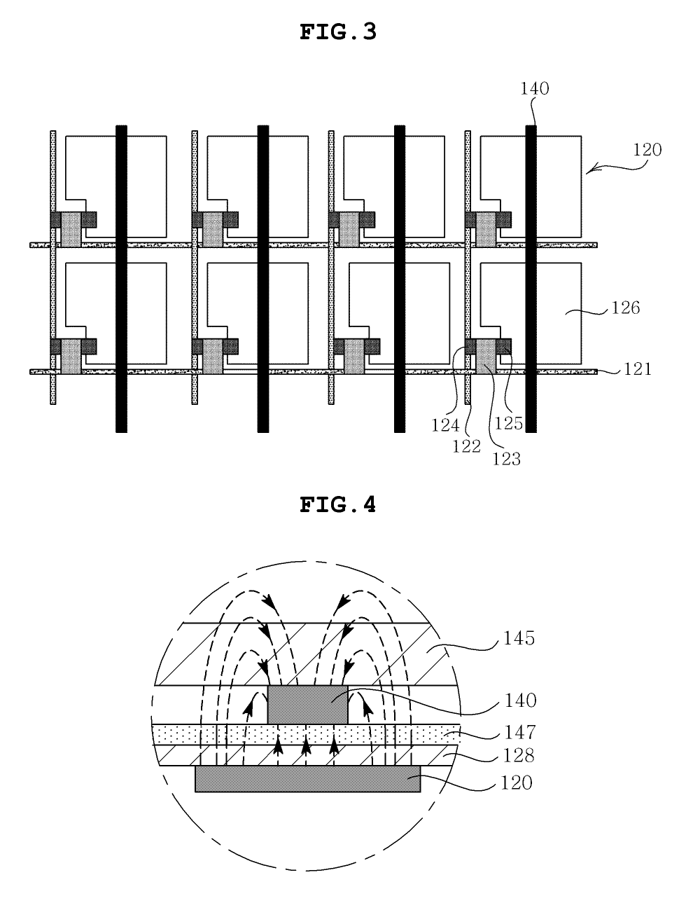

FIGS. 1 and 2 are cross-sectional views of an electronic paper associated with a touch panel according to a preferred embodiment of the present invention, and FIG. 3 is a plan view of the upper electrode and the sensing electrode of FIG. 1.

As shown in FIGS. 1 to 3, an electronic paper 100 associated with a touch panel according to the present embodiment may be configured to include an electronic ink 110 provided between an upper substrate 128 and a lower substrate 135, an upper electrode 120 provided on a bottom surface of the upper substrate 128 to drive the electronic ink 110 and to generate a signal, a lower electrode 130 provided on a top surface of the lower substrate 135 to drive the electronic ink 110, and a sensing electrode 140 formed on a transparent substrate 145 provided on a top side of the upper substrate 128 to form capacitance with the upper electrode 120 due to the signal of the upper electrode 120 and sensing change in the capacitance when the transparent substrate 145 is touched by an input unit 150.

The electronic ink 110 is driven by voltage from the upper electrode 120 and the lower electrode 130 to implement images that can be sensed by a user. The electronic ink 110 is divided into a twist ball type (see FIG. 1) and an electrophoresis type (see FIG. 2).

Herein, the twist ball type coats black/white materials having different charges on hemispheres of particles 111 having a size of about 100 μm, respectively, thereby displaying black/white images through the change in the polarity of voltage applied from the upper electrode 120 and the lower electrode 130. In the twist ball type, the particles 111 rotate according to a predetermined shaft by the applied voltage to absorb, scatter, or reflect light, thereby displaying images.

Meanwhile, the electrophoresis type basically disperses ink microparticles 113 and 115 that scatter light in a dielectric fluid 117 to electrically move them. The electrophoresis type uses a transparent microcapsule 119 having a diameter of 200 μm to 300 μm which includes white microparticles having positive charges, black ink microparticles 115 having negative charges, and a transparent dielectric fluid 117. When voltage is applied to the upper electrode 120 and the lower electrode 130 by mixing the microcapsule 119 with a binder, the ink microparticles 113 having positive charges move in a negative voltage direction and the ink microparticles 115 having negative charges move in a positive voltage direction, thereby displaying images.

The upper electrode 120 is provided on the bottom surface of the upper substrate 128 to serve to drive the electronic ink 110. In this configuration, the upper electrode 120, which is a thin film transistor (TFT) electrode, is configured to include a gate line 121, a data line 122, a gate electrode 123, a source electrode 124, a drain electrode 125, and a pixel 126 (see FIG. 3). At this time, the gate line 121 is formed in a row direction and the data line 122 is formed in a column direction, thereby intersecting with each other. In addition, the source electrode 124 extended from the date line 122 is arranged opposite to the drain electrode 125 based on the gate electrode 123 extended from the gate line 121. Herein, the gate electrode 123 functions as a switch determining whether the drain electrode 125 is conducted with the source electrode 124. In other words, when the gate electrode 123 receives a scan signal from the gate line 121 to form an electric field, electrons flow between the drain electrode 125 and the source electrode 124, such that a data voltage applied from the data line 122 is finally transferred to the pixel 126 through the source electrode 124 and the drain electrode 125, thereby driving the electronic ink 110. Meanwhile, the gate line 121 and the data line 122 may be formed of a single layer made of silver (Ag), a silver (Ag) alloy, aluminum (Al) or an aluminum (Al) alloy, having low specific resistance, wherein a layer made of a material having excellent physical and electrically contact characteristics such as chrome (Cr), titanium (Ti), tantalum (Ta), or the like, may be additionally formed on the single layer.

In addition, the upper electrode 120 not only drives the electronic ink 110 but also functions as a driving electrode of a touch panel. In other words, the upper electrode 120 generates a sine signal, a pulse signal, or the like to form capacitance with the sensing electrode 140, thereby making it possible to implement a mutual capacitive touch panel. Since the upper electrode 120 functions as the driving electrode of the touch panel, there is no need to form a separate driving electrode. As a result, it is possible to simplify a structure of the electronic paper 100 associated with a touch panel and to make the electronic paper 100 associated with a touch panel thin. A detailed process to calculate touched coordinates by using the capacitance between the upper electrode 120 and the sensing electrode 140 will be described below.

The lower electrode 130 is provided on the top surface of the lower substrate 135 to serve to drive the electronic ink 110, together with the upper electrode 120. Herein, the lower electrode 130 may not only be formed of a TFT electrode but also be formed of a common electrode to which a common voltage having a predetermined magnitude is applied, similar to the upper electrode 120.

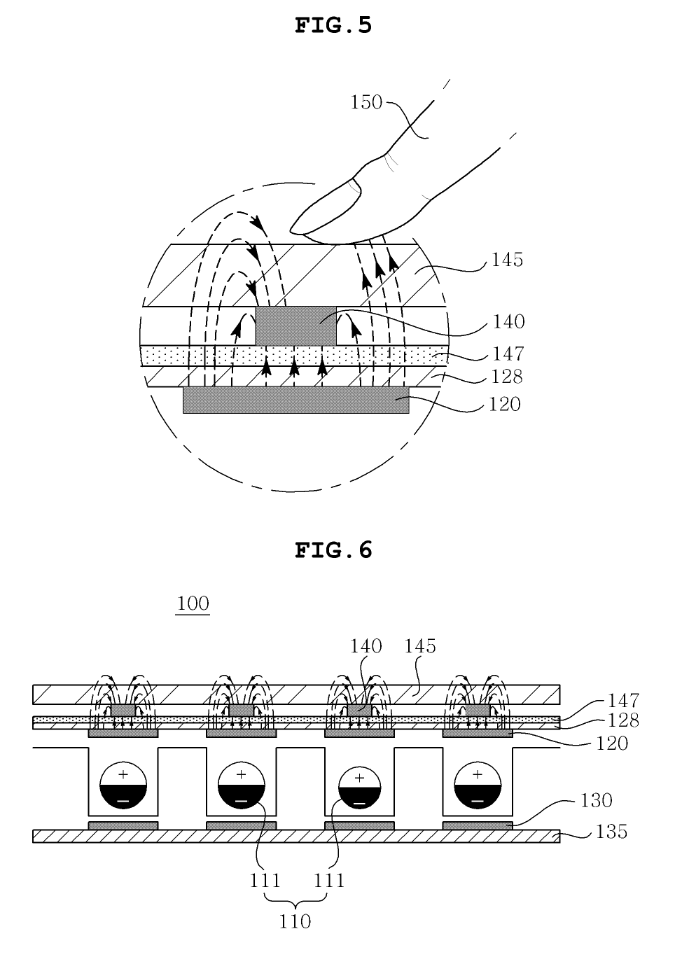

The sensing electrode 140 is provided on the top side of the upper substrate 128 to sense a touch of an input unit 150 (a user's finger, a stylus pen, or the like). FIGS. 4 and 5 are partially enlarged views enlarging portion “A” of the electronic paper associated with a touch panel of FIG. 1. A process of sensing a touch of an input unit 150 will be described with reference to FIGS. 4 and 5. First, the upper electrode 120 generates a sign signal, a pulse signal, or the like, to form capacitance between the upper electrode 120 and the sensing electrode 140 (see FIG. 4). Thereafter, when a transparent substrate 145 is touched by the input unit 150, a portion of charges is flowed into the input unit 150 to change the capacitance between the sensing electrode 140 and the upper electrode 120 and the sensing electrode 140 senses and the change in the capacitance (see FIG. 5). The change in the capacitance sensed by the sensing electrode 140 is finally transferred to a controller, thereby making it possible to calculate touched coordinates of the input unit 150. In addition, it is preferable that the lower electrode 130 is maintained at high-impedance when the transparent substrate 145 is touched by the input unit 150, in order to prevent the electronic ink 110 from being arbitrarily driven while calculating the touched coordinates.

Meanwhile, the sensing electrode 140 may be made of a conductive polymer having excellent flexibility and a simple coating process as well as indium tin oxide (ITO) that is commonly used. At this time, the conductive polymer includes poly-3, 4-ethylenedioxythiophene/polystyrenesulfonate (PEDOT/PSS), polyaniline, polyacetylene, polyphenylenevinylene, or the like. In addition, the sensing electrode 140 may be formed by a dry etching process such as sputtering, evaporation, or the like, a wet etching process such as dip coating, spin coating, roll coating, spray coating, or the like, or a direct patterning process such as screen printing, gravure printing, inkjet printing or the like.

Further, although the sensing electrode 140 may be directly formed on the top side of the upper substrate 128, it is preferable that the sensing electrode 140 is formed on a separate transparent substrate 145 and is then attached to the upper substrate 128 using an adhesive layer 147, for convenience of the manufacturing process. In this case, the adhesive layer 147 may ensure transparency by using an optical clear adhesive (OCA). In addition, the transparent substrate 145, which is touched by the input unit 150, may be made of polyethyleneterephthalate (PET), polycarbonate (PC), polymethylmethacrylate (PMMA), polyethylenenaphthalate (PEN), polyethersulfone (PES), cyclic olefin polymer (COC), triacetylcellulose (TAC) film, polyvinyl alcohol (PVA) film, polyimide (PI) film, polystyrene (PS), biaxially oriented polystyrene (BOPS; containing K resin), glass or reinforced glass, and so on, but is not always limited thereto. Meanwhile, it is preferable that a high frequency treatment or a primer treatment is performed on the transparent substrate 145 in order to improve adhesion between the transparent substrate 145 and the sensing electrode 140.

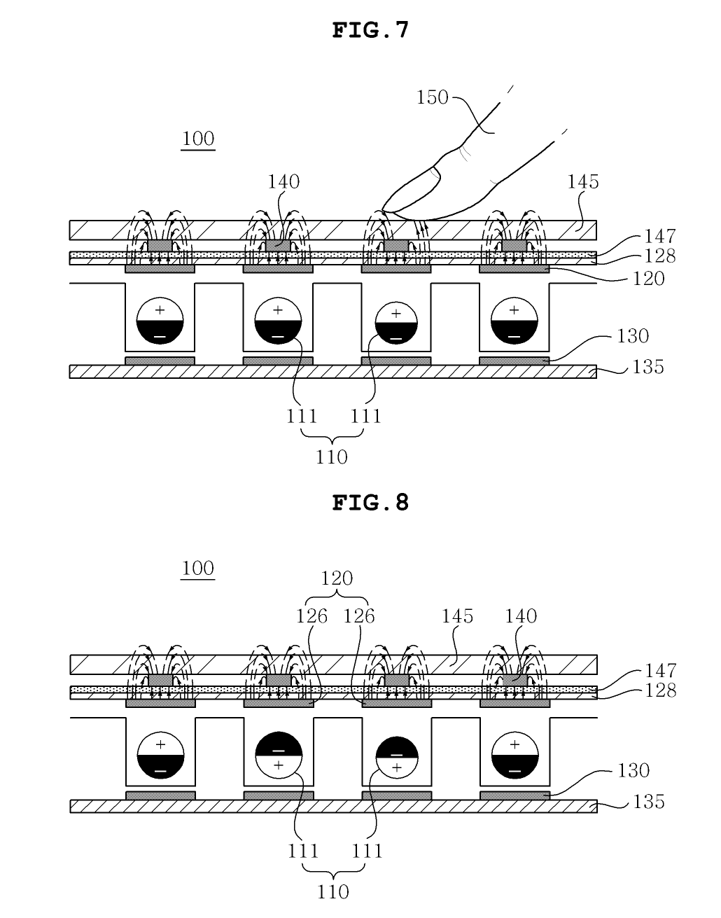

FIGS. 6 to 8 are cross-sectional views showing an operation process of the electronic paper associated with a touch panel of FIG. 1. An operation process of the electronic paper associated with a touch panel according to the present embodiment will be described with reference to FIGS. 6 to 8.

First, as shown in FIG. 6, the electronic paper 100 associated with a touch panel is prepared. At this time, white hemispheres of all the particles 111 of the electronic paper 100 associated with a touch panel face upward, before displaying images. Therefore, a user may sense that the electronic paper 100 associated with a touch panel is entirely white. Meanwhile, the upper electrode 120 generates signals so as to sense the touch of the input unit 150, such that capacitance is formed between the upper electrode 120 and the sensing electrode 140.

Then, as shown in FIG. 7, the touched coordinates of the input unit 150 are calculated. When the transparent substrate 145 is touched by the input unit 150, a portion of the charges is flowed into the input unit 150 to change the capacitance between the upper electrode 120 and the sensing electrode 140 and the sensing electrode 140 senses and transfers the change in the capacitance to the controller, thereby making it possible to calculate the touched coordinates. In this case, it is preferable to prevent the electronic ink 110 from being arbitrarily driven by maintaining of the lower electrode 130 at high-impedance.

Then, as shown in FIG. 8, images are implemented by driving the electronic ink 110 according to the calculated touched coordinates. In order to implement images corresponding to the touched coordinates, voltage is applied to the upper electrode 120 and the lower electrode 130. At this time, the upper electrode 120 is formed of a TFT electrode, thereby making is possible to selectively apply positive voltage only to specific pixels 126. Therefore, the black hemispheres having negative charges of the particles 111 disposed on the specific pixels 126 rotate to face upward. As a result, the user can sense that images are implemented in black on the white background.

The electronic paper 100 associated with a touch panel according to the present embodiment integrally combines an electronic paper with a touch panel, thereby making it possible to intuitively input information, while maintaining a thin thickness, which is the advantage of the electronic paper. In addition, the upper electrode 120 functions as a driving electrode of a touch panel, such that there is no need to form a separate driving electrode, thereby making it possible to simplify a structure of the electronic paper 100 associated with a touch panel.

According to the present invention, the electronic paper is integrally combined with the touch panel by using the upper electrode of the electronic paper as a driving electrode of the touch panel, thereby making it possible to intuitively input information, while maintaining a thin thickness, which is the advantage of the electronic paper.

Although the preferred embodiments of the present invention have been disclosed for illustrative purposes, they are for specifically explaining the present invention and thus the electronic paper associated with a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An electronic paper associated with a touch panel, comprising:
an electronic ink provided between an upper substrate and a lower substrate;
an upper electrode provided on a bottom surface of the upper substrate to drive the electronic ink and generate a signal;
a lower electrode provided on a top surface of the lower substrate to drive the electronic ink; and
a sensing electrode formed on a transparent substrate and provided on a top side of the upper substrate to form capacitance with the upper electrode due to the signal and senses the change in the capacitance when the transparent substrate is touched by an input unit.

2. The electronic paper associated with a touch panel as set forth in claim 1, wherein the sensing electrode is formed on the transparent substrate and is then attached to the upper substrate using an adhesive layer.

3. The electronic paper associated with a touch panel as set forth in claim 2, wherein the adhesive layer is an optical clear adhesive (OCA).

4. The electronic paper associated with a touch panel as set forth in claim 1, wherein when the transparent substrate is touched by the input unit, the lower electrode has high-impedance.

5. The electronic paper associated with a touch panel as set forth in claim 1, wherein the electronic ink is a twist ball type or an electrophoresis type.

6. The electronic paper associated with a touch panel as set forth in claim 1, wherein the upper electrode is a thin film transistor (TFT) electrode.

7. The electronic paper associated with a touch panel as set forth in claim 1, wherein the lower electrode is a common electrode.

8. The electronic paper associated with a touch panel as set forth in claim 1, wherein the sensing electrode is made of a conductive polymer.

9. The electronic paper associated with a touch panel as set forth in claim 8, wherein the conductive polymer includes poly-3, 4-ethylenedioxythiophene/polystyrenesulfonate (PEDOT/PSS), polyaniline, polyacetylene, or polyphenylenevinylene.
